(19) United States
(12) Patent Application Publication
(10) Pub. No.: US 2011/0206806 A1
(43) Pub. Date: Aug. 25, 2011

(54) Methods for Recovering Lactase Enzyme

(76) Inventors: Shakeel Ur-Rehman, Meridian (IN); John M. Dunker, Coloradi Springs, CO (US)

(21) Appl. No.: 12/741,033

(22) PCT Filed: Nov. 2, 2008
(86) PCT No.: PCT/US2008/082174

§ 371 Date: Aug. 13, 2010

Related U.S. Application Data
(60) Provisional application No. 60/985,129, filed on Nov. 2, 2007.

(51) Int. Cl. A23C 9/12; A23C 9/142

(52) U.S. Cl. 426/42

(57) ABSTRACT

This invention relates to methods of recovering lactase from a dairy fraction. The methods of the invention provide for retrieving and recycling lactase enzyme in a time-efficient and cost-efficient manner, such that the enzyme can be reused thereby lowering the overall costs of the process. Embodiments of the invention are directed to methods of recovering lactase from a dairy fraction such as membrane filtration and centrifugation processes.

### CROSS REFERENCES TO RELATED APPLICATIONS

This application claims the benefit of U.S. Provisional Application 60/985,129, filed Nov. 2, 2007.

### FIELD OF THE INVENTION

This invention relates to a method of recovering lactase from a dairy fraction.

The conversion of lactose into glucose and galactose is of great interest both in food technology and nutrition. Commercially. lactase enzyme has been used in dairy technology for manufacturing low lactose or lactose free milks, lactose hydrolyzed whey or products therefrom.

Commercially available lactase enzyme is obtained from yeasts and is very expensive. The cost of enzyme in low lactose and lactose-free milk is $0.35-$0.40/gallon. The widely used method of lactase hydrolysis in milk processing is a batch-type process, in which a predetermined quantity of enzyme is added to a batch of milk and the enzyme-treated milk is held at a specific temperature until desired lactose hydrolysis is achieved. In the batch-type process, nearly all of the enzyme is discarded after the hydrolysis step, thus creating a need for new enzyme to be used each and every time, and leading to increased costs. Flow-through reactors in which lactase enzyme is immobilized require high initial capital expenditure and the maintenance and cleaning of such systems are expensive and time consuming.

Thus, there is a need for a method to retrieve or recycle the lactase enzyme in a time-efficient and cost-efficient manner, such that the enzyme can be reused thereby lowering the overall costs of the process. The present invention meets this need.

### SUMMARY OF THE INVENTION

The invention relates to a method of retrieving lactase enzyme from a dairy fraction.

In one embodiment, the lactase enzyme is isolated after subjecting the dairy fraction to a filtration step.

In an embodiment of the invention, the filtration step is ultrafiltration. In another embodiment of the invention, the filtration step is microfiltration.

The present invention also relates to a method of producing a glucose and galactose containing composition from a dairy stream wherein the method comprises hydrolyzing a lactose component of a dairy stream comprising lactose, and isolating lactase enzyme from the fraction.

In another aspect of the present invention, the lactase enzyme is isolated by membrane filtration.

In yet another aspect of the present invention, the membrane filtration step is ultrafiltration.

### BRIEF DESCRIPTION OF THE DRAWINGS

FIG. 1 illustrates a first method of separating milk components.

FIG. 2 illustrates a second method of separating milk components.

FIG. 3 illustrates a third method of separating milk components.

### DETAILED DESCRIPTION OF ILLUSTRATIVE EMBODIMENTS

The present invention is based in part on the discovery that lactase enzyme is easily separated from a dairy fraction by a membrane filtration process.

A method, according to the present invention, for recovering lactase enzyme proceeds as follows. The dairy stream is initially filtered to remove salts, fats, protein, peptides, or other suspended solid waste. Additionally, the dairy stream may be filtered at multiple later steps in the process wherein components of milk are separated. The lactase enzyme is added to the dairy stream to hydrolyze lactose into glucose and galactose. The enzyme may be added prior to or following filtration. The pH and temperature of the dairy stream may be adjusted to facilitate the preferential hydrolysis of lactose. The dairy stream may then be filtered again to separate the lactase enzyme from the hydrolyzed lactose. This can be accomplished by filtration because of the difference in the molecular weight between glucose and galactose (180) and that of lactase enzyme (120,000 to 400,000). The final product may be filtered again to remove any traces of enzyme, and to recover the enzyme for further use.

An enzyme is a biological catalyst that accelerates a biochemical reaction without itself undergoing any permanent chemical change. Lactase (β-galactosidase, EC 3.2.1.23) is used in dairy industry for converting milk sugar (lactose) into its monosaccharides glucose and galactose. The conversion of lactose into glucose and galactose is of great interest both in food technology and nutrition due to several reasons. The products of lactose obtained by lactase treatment have a sweeter taste, are more soluble, are more easily fermented and are more readily absorbed from mammalian intestine than lactose. A large section of human population is lactose intolerant, and therefore, cannot consume milk and dairy products containing lactose. However, lactase-treated milks or milk products would be suitable for these individuals. Commercially, lactase enzyme has been used in dairy technology for manufacturing low-lactose/lactose-free milk, lactose hydrolyzed whey or products from them. Additionally, hydrolysis of lactose in ice cream and condensed and evaporated milks helps in preventing the product from acquiring a sandy texture during extended storage, thereby increasing shelf-life and palatability.

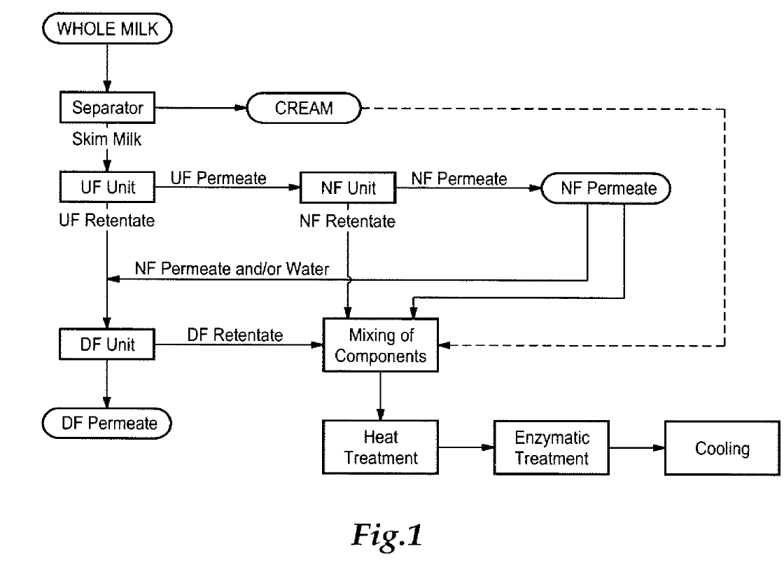

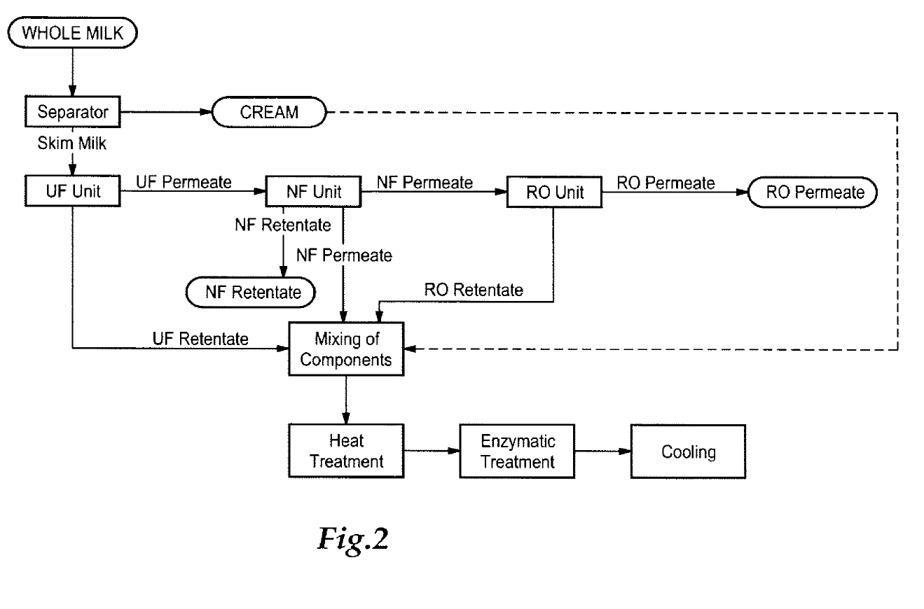

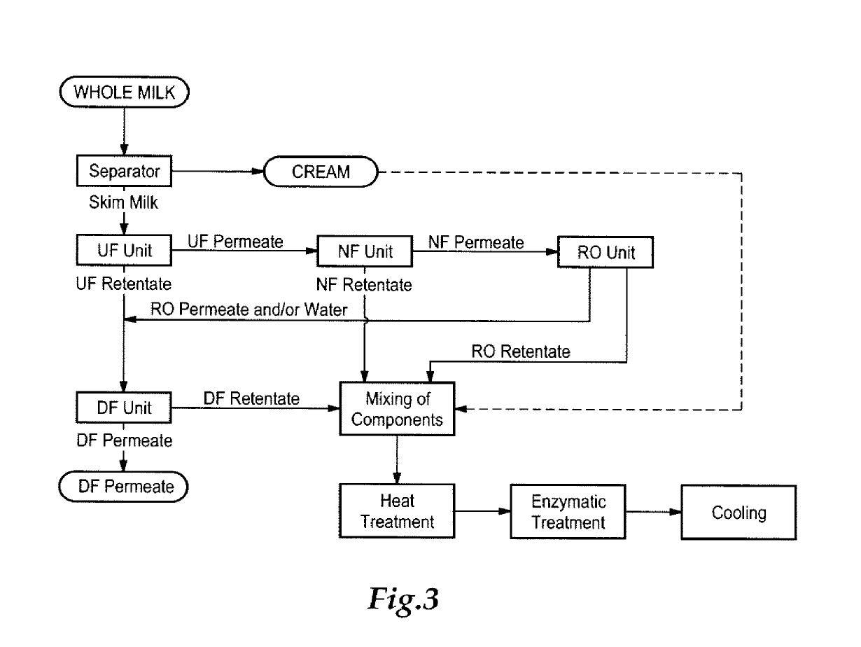

In an embodiment of the invention, raw milk is fractionated into different components by centrifugal separators, ultrafiltration/diafiltration, nanofiltration and reverse osmosis processes. FIGS. 1-3 illustrate representative processes that utilize membrane filtration steps in order to separate milk components present in raw milk or skim milk. A defined quantity of a lactose rich component called nanofiltration retentate (NF retentate) is treated with a specific quantity of lactase enzyme and the lactose of NF retentate is hydrolyzed in a specific time (ranging from 6-10 hours) and at temperatures below 44° F. (ranging from 42° F. to 45° F.). Once the hydrolysis of lactose is complete, the enzyme from concentrate containing hydrolyzed lactose is separated by cold ultrafiltration process. The cold ultrafiltration process is performed using a membrane filtration system having a molecular weight cut-off of about 8-10 kDa at pressures ranging from about 45 to about 150 psi at a temperature below 45° F.

The molecular weight of glucose is 180 daltons while that of galactose is also 180 daltons. However, the molecular weight of lactase enzyme is 120,000 to 400,000 daltons. When the hydrolysed NF retentate fraction is subjected to the ultrafiltration process, the major components of glucose and galactose easily pass the membranes (in the ultrafiltration permeate fraction) while lactase enzyme is retained in the ultrafiltration retentate fraction. The lactase enzyme solution in the ultrafiltration retentate fraction is used to hydrolyze lactose in other ingredients used in the manufacture of milk. Following hydrolysis, the NF retentate fraction is used as an ingredient in the manufacture of lactose-free dairy products for standardization of sugar.

Embodiments of the invention employ stepwise hydrolysis of lactose during different stages of manufacture of lactose-free milks. In other words, any of the membrane filtration fractions depicted in FIGS. 1-3 may be subjected to the lactase hydrolysis step and subsequent enzyme recovery processes of the present invention. Since the retrieved enzyme is re-used for lactose hydrolysis of a subsequent membrane filtration fraction, the overall cost of the enzyme used in the production of lactose-free products is greatly reduced. Additionally, the step-wise addition of enzyme into more than one membrane filtration fractions reduces the processing time because the lactose to be hydrolyzed is split into different fractions thereby requiring less time to be hydrolyzed into glucose and galactose.

An embodiment of the present invention provides a process whereby a defined amount of lactase enzyme is added to a specific quantity of NF-retentate. Following hydrolysis of the existing lactose sugar in the NF-retentate fraction into glucose and galactose, the lactase-containing NF-retentate fraction is used directly as a source of lactase enzyme in subsequent processes. This procedure also reduces the overall cost of enzyme and processing time, and additionally does not require the use of an ultrafiltration unit for enzyme recovery.

An embodiment of the invention also provides for the separation of the lactase enzyme by centrifugation of the hydrolyzed NF retentate fraction. The centrifugation process causes the lactase enzyme (which has a higher molecule weight than the other components found in the NF-retentate fraction) to form a pellet, and thus separates it from the remaining components which stay in the supernatant.

In addition to cost savings, reusing lactase enzyme is also advantageous from the point of view of recycling, causing less waste and increasing conservation of resources.

What is claimed is:

1. A method of processing a lactose-containing milk fraction, the method comprising:
(i) contacting the milk fraction with lactase enzyme;
(ii) hydrolyzing the lactose in the milk fraction into lactose hydrolysis by-products;
(iii) separating the lactase enzyme from the lactose hydrolysis by-products; and
(iv) utilizing the separated lactase enzyme for a subsequent lactose hydrolysis step.

2. The method of claim 1, wherein the lactase enzyme is separated from the lactose hydrolysis by-products by membrane filtration.

3. The method of claim 2, wherein the membrane filtration is ultrafiltration.

4. The method of claim 1, wherein the lactase enzyme is separated from the lactose hydrolysis by-products by centrifugation.

5. A method of preparing a glucose and galactose containing composition from a lactose-containing milk fraction, the method comprising:
(i) contacting the milk fraction with lactase enzyme;
(ii) hydrolyzing the lactose in the milk fraction into lactose hydrolysis by-products;
(iii) isolating a glucose and galactose containing composition;
(iv) isolating the lactase enzyme from the milk fraction; and
(v) utilizing the separated lactase enzyme for a subsequent lactose hydrolysis step.

6. The method of claim 5, wherein the lactase enzyme is isolated from the milk fraction by membrane filtration.

7. The method of claim 6, wherein the membrane filtration is ultrafiltration.

8. The method of claim 5, wherein the lactase enzyme is isolated from the milk fraction by centrifugation.
